(19) United States
(12) Patent Application Publication
(10) Pub. No.: US 2017/0300192 A1
(43) Pub. Date: Oct. 19, 2017

(54) METHOD OF PROVIDING MULTI-SCREEN ENVIRONMENT AND APPARATUS THEREOF

(71) Applicant: SAMSUNG ELECTRONICS CO., LTD., Suwon-si (KR)

(72) Inventors: Jean Christophe NAOUR, Seoul (KR); Jae JULIEN, Seoul (KR)

(73) Assignee: SAMSUNG ELECTRONICS CO., LTD., Suwon-si (KR)

(21) Appl. No.: 15/459,685

(22) Filed: Mar. 15, 2017

(30) Foreign Application Priority Data
Apr. 14, 2016 (KR) 10-2016-0045804

(51) Int. Cl. G06F 3/0482; G06F 3/0488

(52) U.S. Cl. CPC G06F 3/0482; G06F 3/0488

(57) ABSTRACT

A method and apparatus for providing a multi-screen environment as a more effective user interface are disclosed. The apparatus may include a user interface, a display, and a processor. While first content is being displayed on the display, when a user input representing a request to start second content is received through a user interface, the processor may control the display to concurrently display the second content in a main screen of the display and the first content in a sub-screen of the display in response to the received user input.

### CROSS-REFERENCE TO RELATED APPLICATION

This application claims priority from Korean Patent Application No. 10-2016-0045804, filed on Apr. 14, 2016 in the Korean Intellectual Property Office, the disclosure of which is incorporated herein in its entirety by reference.

### BACKGROUND

### 1. Field

Methods and apparatuses consistent with exemplary embodiments relate to a display apparatus, and more particularly, to a method and apparatus for providing a multiscreen environment.

### 2. Description of the Related Art

Display devices such as televisions (TVs) have become increasingly more sophisticated in their functions and capabilities. The recent developments in smart TVs allow users to receive TV broadcasts, execute various applications, and browse the Internet. In addition, there have been attempts to combine smart TVs with multi-screen displays.

However, a user interface (UI) for providing a multi-screen environment is not a simple matter. For example, in order to execute an additional application or an Internet browser while watching a live TV broadcast, a user may have to perform multiple steps of selection menu items and be temporarily prevented from watching the live TV broadcast. Additionally, when a multiscreen display is provided, the UI may not necessarily be specifically designed for a particular screen being used. For this reason, a display apparatus may inadvertently perform a function based on an unintentional user input.

Therefore, there exists a need for a multiscreen environment equipped a UI that is more effective and does not adversely affect the user experience.

### SUMMARY

Exemplary embodiments provide a method and apparatus for providing a multiscreen as a more effective user interface (UI).

Additional aspects will be set forth in part in the description which follows and, in part, will be apparent from the description, or may be learned by practice of the presented embodiments.

According to an aspect of an exemplary embodiment, an apparatus may include: a user interface configured to receive a user input; a display; and a processor configured to, while first content is being displayed on the display, receive, through the user interface, a user input representing a request to start second content, and, in response to the received user input representing the request to start the second content, control the display to concurrently display the second content in a main screen of the display and the first content in a sub-screen of the display.

When a user input representing state maintenance is received through the user interface before a specific time duration elapses after the user input representing the request to start the second content is received, the processor may control the display to maintain a state where the second content is displayed in the main screen and the first content is displayed in the sub-screen. When the user input representing state maintenance is not received until the specific time duration elapses after the user input representing the request to start the second content is received, the processor may control the display to close the sub-screen.

When a user input representing a menu request is received through the user input interface while one of the main screen and the sub-screen is being focused, the processor may provide, through the display, a dedicated menu corresponding to the focused screen.

The dedicated menu may include one or more menu items for at least one of toggling between multiple screens, reducing screen size of the focused screen, increasing screen size of the focused screen, moving a screen, and terminating a multi-screen configuration.

When a user input representing a request to start third content is received through the user interface while one of the main screen and the sub-screen is being focused, the processor may control the display to display the third content on the focused screen.

When a user input representing a previous content search is received through the user interface, the processor may control the display to sequentially display previously selected content items on the sub-screen.

When a user input representing a previous content search is received through the user interface, the processor may control the display to display previously selected content items on a plurality of sub-screens, a number of the plurality of sub-screens corresponding to a number of the previously selected content items.

According to an aspect of another exemplary embodiment, a method of providing a multi-screen environment includes: displaying first content on a display included in an apparatus; while the first content is being displayed on the display, receiving, through a user interface included in the apparatus, a user input representing a request to start second content; and in response to the received user input representing the request to start the second content, concurrently displaying the second content in a main screen of the display and the first content in a sub-screen of the display.

The method may further include, when a user input representing state maintenance is received through the user interface before a specific time duration elapses after the user input representing the request to start the second content is received, maintaining a state where the second content is displayed in the main screen and the first content is displayed in the sub-screen; and in response to the user input representing state maintenance being not received through the user interface until the specific time duration elapses after the user input representing the request to start the second content is received, closing the sub-screen in the display.

The method may further include, when a user input representing a menu request is received through the user interface while one of the main screen and the sub-screen is being focused, providing, through the display, a dedicated menu corresponding to the focused screen.

The method may further include receiving a user input representing a request to start third content through the user interface while one screen of the main screen and the sub-screen is being focused; and displaying the third content on the focused screen.

The method may further include, when a user input representing a previous content search is received through the user interface, sequentially displaying previously selected content items on the sub-screen.

The method may further include, when a user input representing a previous content search is received through the user interface, displaying previously selected content items on a plurality of sub-screens, a number of the plurality of sub-screens corresponding to a number of the previously selected content items.

According to an aspect of another exemplary embodiment, a non-transitory computer-readable storage medium storing a program for executing a method of providing a multi-screen environment in a computer is provided.

### BRIEF DESCRIPTION OF THE DRAWINGS

The above and/or other aspects will become apparent and more readily appreciated from the following description of exemplary embodiments, taken in conjunction with the accompanying drawings in which:

FIG. 1 illustrates a method, performed by an apparatus, of providing a multiscreen multi-screen display, according to an exemplary embodiment;

FIG. 2 illustrates a multi-screen environment of an apparatus, according to an exemplary embodiment;

FIGS. 3A, 3B and 3C illustrate a multi-screen environment with a dedicated menu of an apparatus, according to an exemplary embodiment;

FIG. 4 illustrates an operation of reducing a size of a main screen in a multi-screen environment of an apparatus, according to an exemplary embodiment;

FIG. 5 illustrates an operation of changing content in a multi-screen environment of an apparatus, according to an exemplary embodiment;

FIG. 6 illustrates an operation of searching for previous content in a multi-screen environment of an apparatus, according to an exemplary embodiment;

FIG. 7 illustrates an operation of searching for previous content in a multi-screen environment of an apparatus, according to an exemplary embodiment;

FIGS. 8 and 9 are function block diagrams of an apparatus according to an exemplary embodiment; and

FIGS. 10 and 11 are flowcharts of a method of providing a multi-screen environment performed by an apparatus, according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. Expressions such as “at least one of” when preceding a list of elements, modify the entire list of elements and do not modify the individual elements of the list.

Hereinafter, exemplary embodiments will be described in detail to be easily embodied by those of ordinary skill in the art with reference to the accompanying drawings. The inventive concept may, however, be embodied in many different forms and should not be construed as being limited to the embodiments set forth herein. In the accompanying drawings, a portion irrelevant to a description of the inventive concept will be omitted for clarity. Moreover, like reference numerals refer to like elements throughout.

In this disclosure below, when one part (or element, device, etc.) is referred to as being “connected” to another part (or element, device, etc.), it should be understood that the former may be “directly connected” to the latter, or “electrically connected” to the latter via an intervening part (or element, device, etc.). Furthermore, when it is described that one comprises (or includes or has) some elements, it should be understood that it may comprise (or include or has) only those elements, or it may comprise (or include or have) other elements as well as those elements if there is no specific limitation.

Hereinafter, exemplary embodiments will be described in detail with reference to the accompanying drawings. In the following description, “providing content through a screen” may denote that the content is displayed on the screen. When a screen is “focused” or “has focus,” an apparatus 100 may output an audio signal corresponding to content displayed on the focused screen, but in the present embodiment, an environment for outputting the audio signal is not limited thereto.

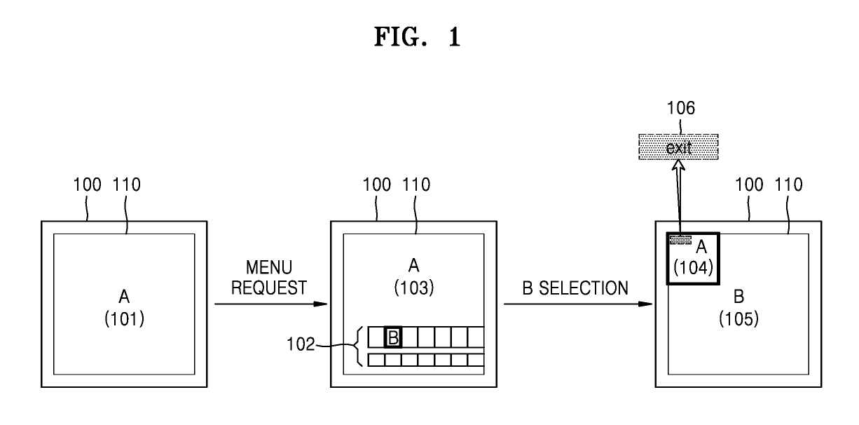

FIG. 1 illustrates a method of providing a multi-screen display by the apparatus 100 according to an exemplary embodiment. A multi-screen display or a multi-screen environment described herein may provide content by displaying a plurality of virtual screens on one or more physical monitors and may also be referred to as a multilink screen. Also, a method of providing a multi-screen display may involve providing a multi-screen environment based on an interface between the apparatus 100 and a user. This interaction between the multi-screen environment and the user may be referred to as a multi-screen interaction.

According to an aspect of an exemplary embodiment, content may include at least one piece of content capable of being selected from a home screen. However, the at least one piece of content is not limited to content capable of being selected from the home screen.

The at least one piece of content may include, for example, content based on a live TV broadcast, content based on an application installed in the apparatus 100, content based on Internet search or web streaming, and/or content based on at least one source, but the at least one piece of content is not limited to the above description.

The at least one source according to an exemplary embodiment may include a source based on hardware included in the apparatus 100. The at least one source may include, for example, a secondary tuner, a video gaming console, a personal computer (PC), a MoMA, a Blue-ray disc player, etc. connected through, for example, High Definition Multimedia Interface (HDMI) or Universal Serial Bus (USB). The at least one source may be based on a connection between the apparatus 100 and an external device. The connection may be wired, wireless, or both.

As shown in FIG. 1, the apparatus 100 may be an electronic device including a display 110. For example, the apparatus 100 may be a smart TV, a smartphone, a tablet personal computer (PC), a mobile device, an E-book reader, a desktop PC, a laptop PC, a netbook PC, a personal digital assistant (PDA), a portable multimedia player (PMP), an MPEG audio layer-3 (MP3) player, a medical device, a digital camera, or a wearable device, but is not limited thereto.

In FIG. 1, while a screen 101 containing content A is being displayed by the display 110, when a user input representing a menu request is received, the apparatus 100 may display a menu list 102 including a plurality of menu items on the screen 101.

The apparatus 100 may provide the menu list 102 in the form of an on-screen display (OSD). In FIG. 1, the apparatus 100 may provide the menu list 102 by using a lower portion of the screen 101. In an exemplary embodiment, a position at which the menu list 101 is displayed is not limited to what is illustrated in FIG. 1.

For example, the apparatus 100 may provide the menu list 102 at a left portion, a right portion, or an upper portion of the screen 101 in the form of an OSD. Also, the apparatus 100 may provide the menu list 102 by using a screen independent from the screen 101. The independent screen may be a screen which is overlaid on the screen 101 in the form of floating windows (or popup windows), or as part of a divided screen (e.g., picture-in-picture, horizontal/vertical division, tiled, etc.), but the independent screen is not limited to the above description.

According to an aspect of an exemplary embodiment, the user input representing the menu request (i.e., user input for requesting a menu) may be received as a home button on the apparatus 100, but the user input representing the menu request is not limited to the above description. For example, the apparatus 100 may receive the user input representing the menu request as a menu request button on the apparatus 100. The home button or the menu request button may be attached on the apparatus 100 or a remote control device for controlling the apparatus 100 or may be displayed on a touch screen.

If the menu list 102 provided by the apparatus 100 is a smart hub, the menu request may be referred to as a smart hub launch request.

A plurality of menu items included in the menu list 102 may include, for example, a live TV, Netflix, Amazon, Pandora, Hulu, YouTube, Spotify, Skype, Xbox HDMI 1, PC HDMI 2, MoMA USB1, BD HDMI 3, and/or HDMI 4. The plurality of menu items included in the menu list 102 may be provided in the form where a menu item corresponding to at least one piece of content and a menu item corresponding to at least one source are separated from each other. In the present embodiment, the plurality of menu items may include path or link information which enables an access to the at least one piece of content or the at least one source.

When a user input for selecting content B from the menu list 102 is received, the apparatus 100 may display a main screen 105 displaying the content B on the display 110 along with a sub-screen 104 displaying the content A. Therefore, the user may experience the content B, which is selected subsequently, without an experience of the content A being obstructed.

The apparatus 100 may overlay the sub-screen 104 on the main screen 105 in the form of a floating window (e.g., a popup window). The apparatus 100 may divide and provide the sub-screen 104 and the main screen 105 at the same size or in different sizes. In FIG. 1, for example, the apparatus 100 is overlaying the sub-screen 104 on the main screen 105.

The sub-screen 104 displaying the content A may be referred to as a sub-screen 104 for executing the content A, a sub-screen 104 including the content A, or a sub-screen 104 providing the content A. The main screen 105 displaying the content B may be referred to as a main screen 105 for executing the content B, a main screen 105 including the content B, or a main screen 105 providing the content B. In order to differentiate between the sub-screen 104 and the main screen 105, the main screen 105 may be referred to as a primary screen, and the sub-screen 104 may be referred to as a secondary screen.

When both the sub-screen 104 displaying the content A and the main screen 105 displaying the content B are displayed on the display 110, an operation mode of the apparatus 100 may be referred to as a multilink screen active mode. If the operation mode of the apparatus 100 is the multilink screen active mode, information representing the multilink screen active mode may be displayed on a portion of the main screen 105. The apparatus 100 may display the information representing the multilink screen active mode in the form of at least one of icons, symbols, texts, and images. The apparatus 100 may display the information representing the multilink screen active mode in a corner of the main screen 105.

Moreover, FIG. 1, as soon as both the sub-screen 104 displaying the content A and the main screen 105 displaying the content B are displayed on the display 110, the apparatus 100 may focus on the sub-screen 104, based on environment information which is previously set. Accordingly, the user can intuitively know which screen is the focused screen in a multi-screen environment.

In a case where the environment information which is previously set in the apparatus 100 is set to focus on the main screen 105, as soon as both the sub-screen 104 displaying the content A and the main screen 105 displaying the content B are displayed on the display 110, the apparatus 100 may focus on the main screen 105.

As described above, the apparatus 100 may determine a screen which is focused as a default screen, based on the environment information set in the apparatus 100.

In FIG. 1, the focused sub-screen 104 may include a menu item 106 which enables a user input representing a dedicated menu request to be received. Accordingly, the user may use a dedicated user interface (UI) corresponding to a focused screen.

In FIG. 1, the apparatus 100 expresses a menu item 106 as the term “exit,” but an expression of the menu item 106 for receiving a user input representing a dedicated menu request is not limited thereto.

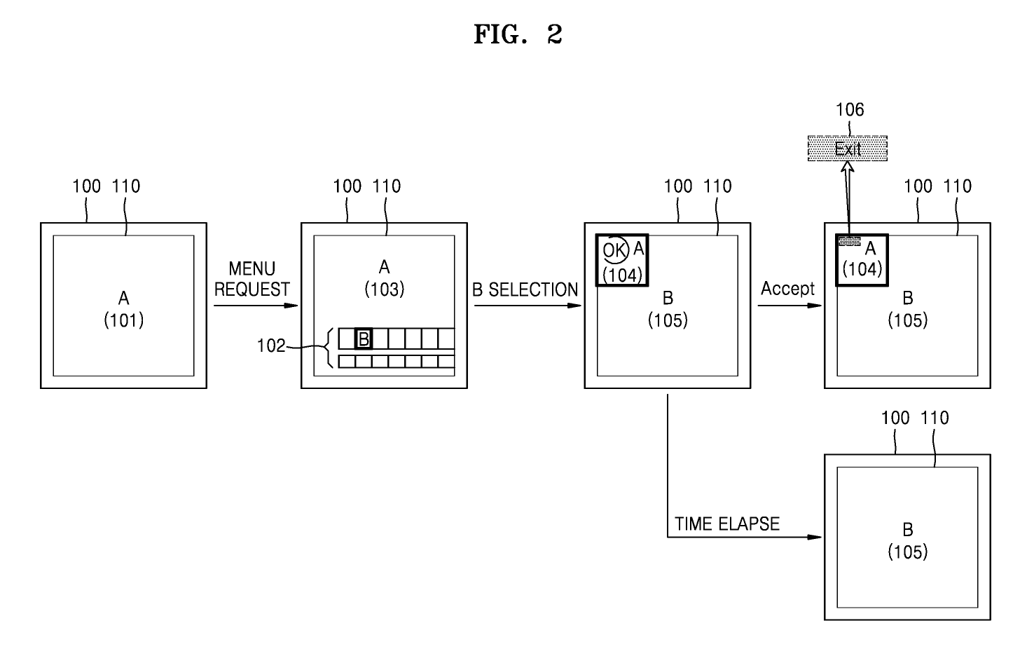

FIG. 2 illustrates a multi-screen environment of the apparatus 100 according to an exemplary embodiment.

In particular, FIG. 2 illustrates an example where an operation of determining whether to maintain the multi-screen configuration is added to the method illustrated in FIG. 1.

In FIG. 2, through the process described above with reference to FIG. 1, while both a sub-screen 104 displaying content A and a main screen 105 displaying content B are being displayed on the display 110, when a user input representing state maintenance (i.e., a user command to maintain the multi-screen configuration) is received, the apparatus 100 may maintain a state where both the sub-screen 104 and the main screen 105 are displayed on the display 110.

The apparatus 100 may provide a guide message, corresponding to the user input representing the state maintenance, through the sub-screen 104. In FIG. 2, as illustrated at a third stage, the apparatus 100 may provide a guide message “press OK button” corresponding to the user input representing the state maintenance. When a user presses the OK button according to the guide message, the apparatus 100 may receive the user input representing the state maintenance. After the user input representing the state maintenance is received, when the apparatus 100 maintains the state where both the sub-screen 104 and the main screen 105 are displayed, the apparatus 100 may provide the sub-screen 104 including the menu item 106. In the present embodiment, the guide message corresponding to the user input representing the state maintenance is not limited to the above description.

The user input “Accept” representing the state maintenance may be received by controlling the OK button. The OK button may be equipped in the apparatus 100, may be equipped in the remote control device, or may be constructed based on a touch screen. The apparatus 100 may provide the sub-screen 104 including an image corresponding to the OK button in order for the user to intuitively recognize that the OK button should be controlled for maintaining a state where both the sub-screen 104 and the main screen 105 are displayed.

As shown in FIG. 2, if the user input representing the state maintenance is not received until a certain time period elapses, the apparatus 100 may close the sub-screen 104 which is being displayed on the display 110, and may display the main screen 105 displaying content B on the display 110. The sub-screen 104 being closed on the display 110 may denote that the sub-screen 104 has disappeared.

When only the main screen 105 is displayed on the display 110, the main screen 105 may include the menu item 106 which enables a user input representing a dedicated menu request to be received.

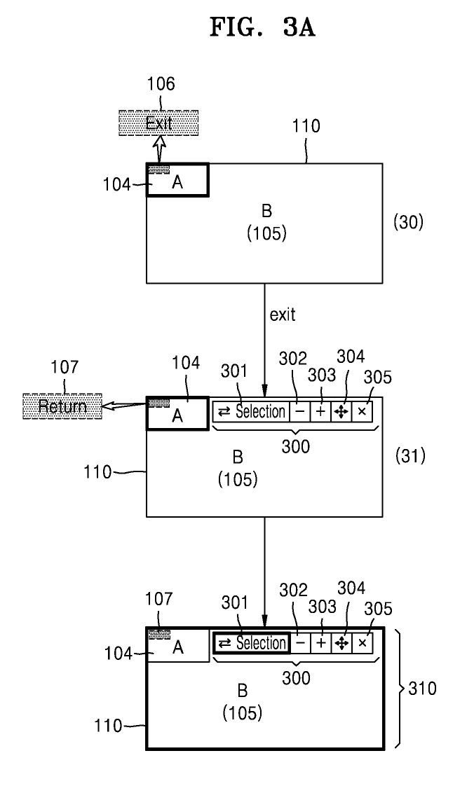

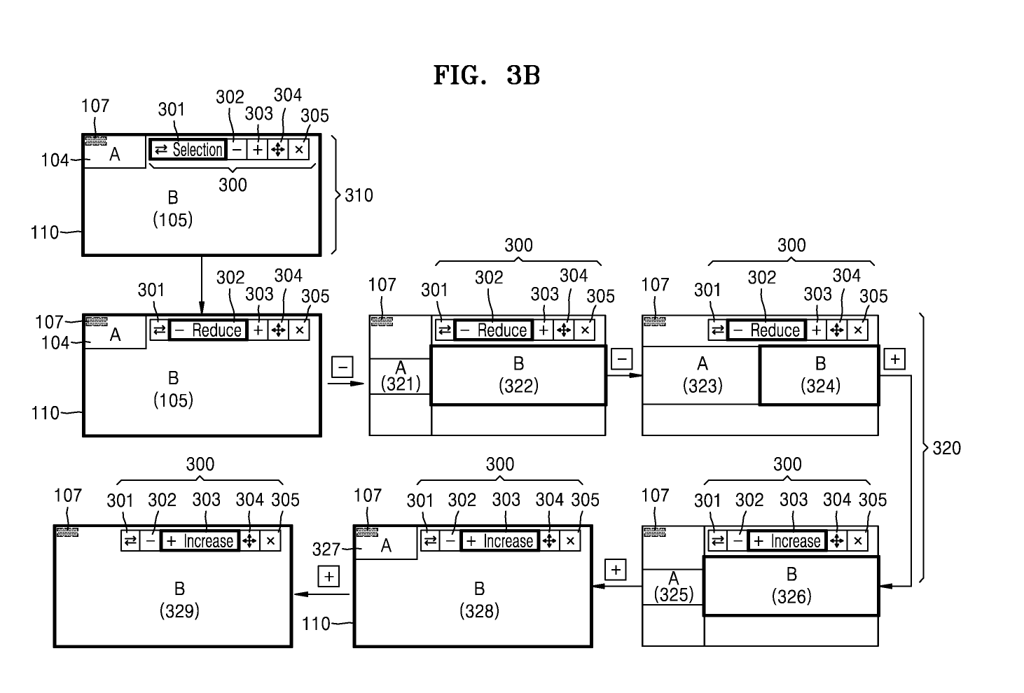

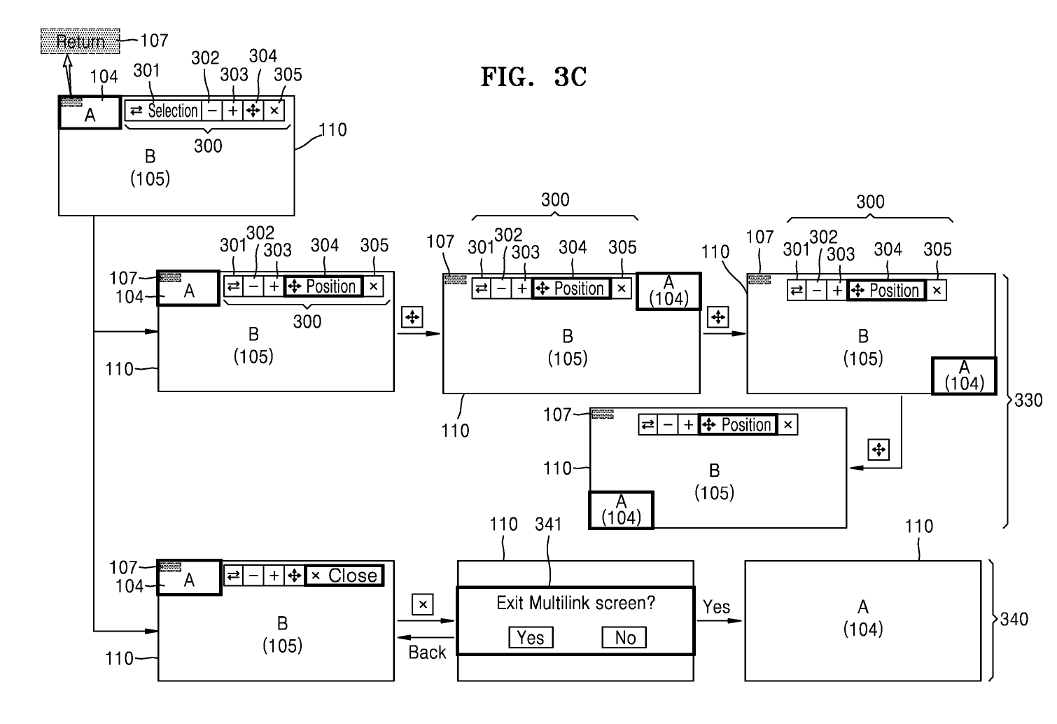

FIGS. 3A to 3C illustrate a multi-screen environment with a dedicated menu of the apparatus 100 according to an exemplary embodiment.

Referring to a screen 30 in FIG. 3A, the apparatus 100 may focus on a sub-screen 104 among the sub-screen 104 and a main screen 105 which are being displayed on the display 110, and may provide an item (hereinafter referred to as a dedicated menu item) 106 which enables a user input representing a dedicated menu request to be received through the sub-screen 104.

While the screen 30 of FIG. 3A is being provided through the display 110, when the dedicated menu item 106 is selected, as illustrated in a screen 31 of FIG. 3A, the apparatus 100 may display a dedicated menu list 300 corresponding to the sub-screen 104 on the display 110. The apparatus 100 may display the dedicated menu list 300 on a display region close to the sub-screen 104, but a display position of the dedicated menu list 300 is not limited to the illustration in the screen 31 of FIG. 3A.

For example, the apparatus 100 may display the dedicated menu list 300 so as to be included in the sub-screen 104. The apparatus 100 may change the display position of the dedicated menu list 300, based on a user input. For example, a cursor may be located on the dedicated menu list 300, and when a user input similar to a drag is received, the apparatus 100 may change the display position of the dedicated menu list 300. A user input for changing the display position of the dedicated menu list 300 is not limited to the above description. For example, the user input for changing the display position of the dedicated menu list 300 may include a touch and drag corresponding to the dedicated menu list 300.

Referring to a screen 31 in FIG. 3A, the dedicated menu list 300 may include an inter-screen focus toggle item 301, a focused-screen size reduce item 302, a focused-screen size increase item 303, a screen move item 304, and a multilink screen end item 305. However, menu items included in the dedicated menu list 300 are not limited to the above description.

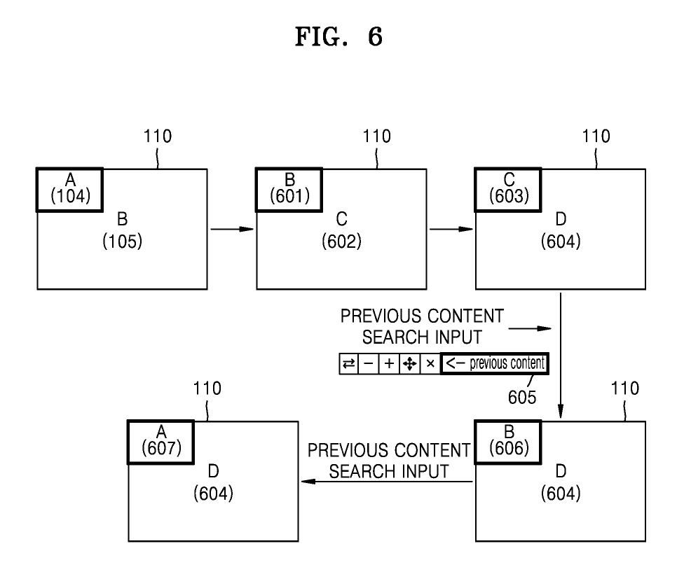

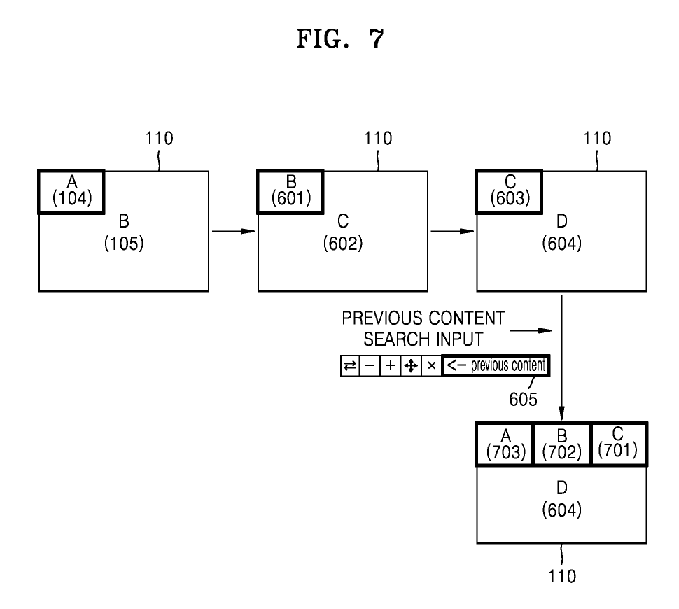

For example, as illustrated in FIGS. 6 and 7, the dedicated menu list 300 may further include a previous content providing item 605. Also, the dedicated menu list 300 may include a smaller number of menu items than the menu items illustrated in the screen 31 of FIG. 3A. For example, if the display 110 is unable to further reduce a size of the sub-screen 104, the dedicated menu list 300 may not include the focused-screen size reduce item 302.

A region in which the apparatus 100 may vary a region which displays an item may vary according to an item selected from the dedicated menu list 300. For example, when the inter-screen focus toggle item 301 is selected from the dedicated menu list 300, the apparatus 100 may use a larger display region, where the inter-screen focus toggle item 301 is displayed, than a region where each of the other items is displayed. When the focused-screen size reduce item 302 is selected from the dedicated menu list 300, the apparatus 100 may use a larger display region, where the focused-screen size reduce item 302 is displayed, than a region where each of the other items is displayed. When the focused-screen size increase item 303 is selected from the dedicated menu list 300, the apparatus 100 may use a larger display region, where the focused-screen size increase item 303 is displayed, than a region where each of the other items is displayed. When the screen move item 304 is selected from the dedicated menu list 300, the apparatus 100 may use a larger region, where the selected screen move item 304 is displayed, than a region where each of the other items is displayed. When the multilink screen end item 305 is selected from the dedicated menu list 300, the apparatus 100 may use a larger display region, where the selected multilink screen end item 305 is displayed, than a region where each of the other items is displayed.

When items included in the dedicated menu list 300 are individually selected, the apparatus 100 may make sizes of regions (or enlarged display regions), where the selected items are respectively displayed, identical or different. For example, the apparatus 100 may identically or differently display a display region, which displays the inter-screen focus toggle item 301 when the inter-screen focus toggle item 301 is selected, and a display region which displays the focused-screen size reduce item 302 when the focused-screen size reduce item 302 is selected.

The apparatus 100 may display an inactive or disabled menu item (or a menu item not selectable by a user) of the menu items included in the dedicated menu list 300 differently from the other menu items. For example, the apparatus 100 may display the inactive menu item to be blurrier than an active menu item. Therefore, the user can intuitively recognize the inactive menu item. Also, the apparatus 100 may not respond to a selection operation corresponding to a menu item which is blurred or grayed out.

In the screen 31 of FIG. 3A, the apparatus 100 may provide an item 107, enabling a menu to be hidden, through the sub-screen 104. The item 107 for hiding a menu may be expressed as “Return,” but the exemplary embodiments are not limited thereto. In the screen 31 of FIG. 3A, when a user input for selecting the inter-screen focus toggle item 301 is received, the apparatus 100 may change a focused screen from the sub-screen 104 to the main screen 105 as illustrated in the screen 310. The apparatus 100 may highlight a screen boundary line in order for the user to intuitively recognize the focused screen, but a method of displaying the focused screen is not limited thereto. For example, the apparatus 100 may set a brightness level (or a luminance level) of a whole screen to a degree which enables the user to see content provided through the focused screen without any obstruction, so as to be differentiated from an unfocused screen. Accordingly, the user can intuitively recognize the focused screen.

When a user input representing a one-time selection of the focused-screen size reduce item 302 as illustrated in screens 320 of FIG. 3B is received in a state where the main screen 105 is focused as illustrated in the screen 310 of FIG. 3A, the apparatus 100 may simultaneously display a main screen 322 having a reduced display size and a sub-screen 321 having a changed display position on the display 110. At this time, the apparatus 100 may maintain a display state and a display position of the sub-screen 104.

While the main screen 322 and the sub-screen 321 are being simultaneously displayed on the display 110, when the user input representing the one-time selection of the focused-screen size reduce item 302 is again received, the apparatus 100 may simultaneously display a main screen 324 having a further reduced display size and a sub-screen 323 having a further increased display size on the display 110.

While the main screen 324 and the sub-screen 323 are being simultaneously displayed, when a user input representing a one-time selection of the focused-screen size increase item 303 is received, the apparatus 100 may simultaneously display a main screen 326 having an increased display size and a sub-screen 325 having a reduced display size on the display 110.

While both the main screen 326 and the sub-screen 325 are being displayed, when the user input representing the one-time selection of the focused-screen size increase item 303 is again received, the apparatus 100 may simultaneously display a main screen 328 having an increased display size and a sub-screen 327 having a reduced display size on the display 110.

While both the main screen 328 and the sub-screen 327 are being displayed, when the user input representing the one-time selection of the focused-screen size increase item 303 is again received, the apparatus 100 may display only a main screen 329 having an increased display size on the display 110.

According to an aspect of an exemplary embodiment, a display environment of each of the main screen 105 and the sub-screen 104 are not limited to the above description, based on the number of selections of the focused-screen size reduce item 302 or the number of selections of the focused-screen size increase item 303. The display of each of the main screen 105 and the sub-screen 104 may be performed depending on a display environment which is previously set in the apparatus 100, based on the number of selections of the focused-screen size reduce item 302 or the number of selections of the focused-screen size increase item 303.

Referring to screens 330 of FIG. 3C, as a user input for selecting the screen move item 304 is received while the sub-screen 104 has focus, the apparatus 100 may change a display position of the sub-screen 104 in the display 110.

The apparatus 100 may overlay screen information for controlling four arrow keys (i.e., left, right, up, and down arrow keys) on the main screen 105, based on the user input for selecting the screen move item 304. The apparatus 100 may overlay the screen information for controlling the four arrow keys on the sub-screen 104. The apparatus 100 may display an arrow key selected based on a user input and unselected arrow keys in the screen information for controlling the four arrow keys, so as to be differentiated from each other. For example, the apparatus 100 may highlight the arrow key selected based on the user input.

Referring to screens included in 340 of FIG. 3C, when a user input for selecting the multilink screen end item 305 is received while the sub-screen 104 has focus, the apparatus 100 may provide a multilink screen end notification message 341. As illustrated in the screens included in 340 of FIG. 3C, the apparatus 100 may overlay the multilink screen end notification message 341 on the sub-screen 104 and the main screen 105. Therefore, the user is hindered in watching content which is provided through the sub-screen 104 and the main screen 105. This may denote that an operation of ending a multilink screen is a significant operation that requires user confirmation. The operation of ending the multilink screen may denote an operation of closing an unfocused screen in the display 110. That is, the operation of ending the multilink screen may denote an operation of maintaining only a focused screen in the display 110. The multilink screen end item 305 may be referred to as a multi-screen end item or terminate multi-screen configuration item.

However, in the present embodiment, a form of providing the multilink screen end notification message 341 is not limited to the illustration in 340 of FIG. 3C. For example, the apparatus 100 may overlay the multilink screen end notification message 341 on only the sub-screen 104. Accordingly, the user is not hindered in watching content provided through the main screen 105.

When a user input (e.g., “yes”) for agreeing to close (or exit) is received through the multilink screen end notification message 341, the apparatus 100 may close the sub-screen 104 and may display only the main screen 105 on the display 110.

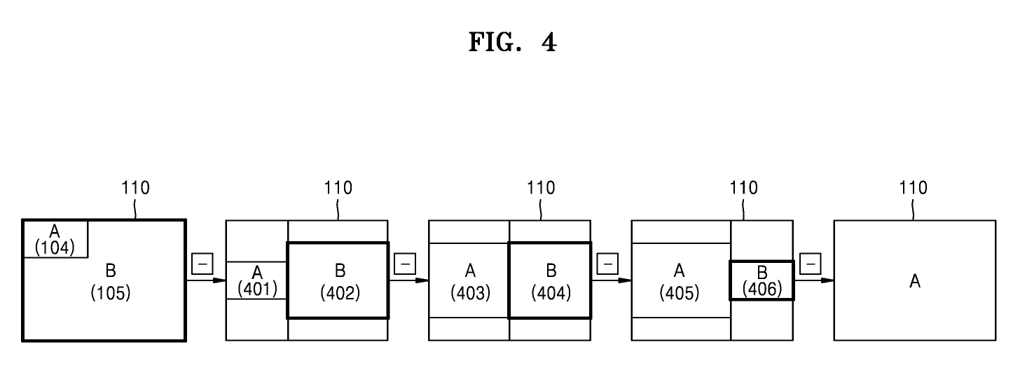

FIG. 4 illustrates an operation of reducing a size of a main screen in a multi-screen environment of the apparatus 100 according to an exemplary embodiment.

In FIG. 4, the operation may correspond to an example where, if a main screen 105 has focus, the apparatus 100 changes a display size or a display position of each of a sub-screen 104 and the main screen 105 whenever the focused-screen size reduce item 302 is selected.

When a user input representing “back” is received while only a sub-screen 407 having an increased display size is being displayed, the apparatus 100 may provide through the display 110 a screen for changing the display size or the display position of each of the sub-screen 104 and the main screen 105 in the reverse order of an order illustrated in FIG. 4, based on the number of receptions of the user input representing “back”.

Therefore, the user may set the display size and the display position of each of the sub-screen 104 and the main screen 105 depending on a preference of the user and may experience performing multitasking.

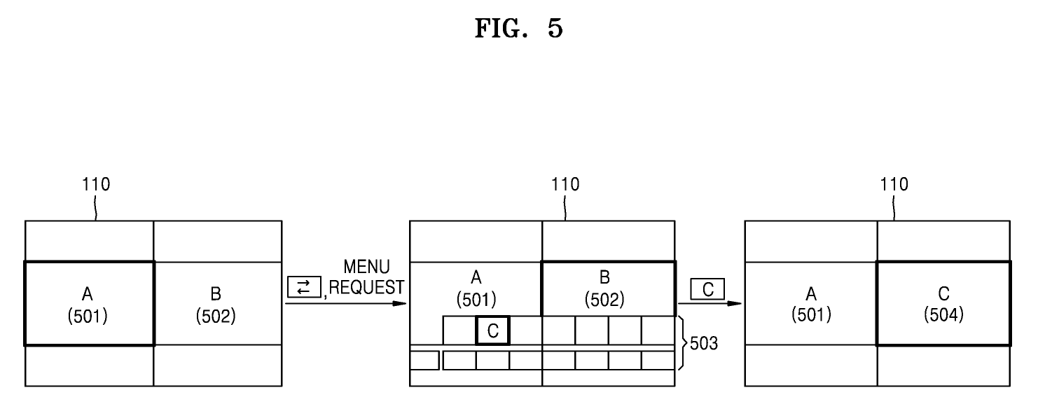

FIG. 5 illustrates an operation of changing content in a multi-screen environment of the apparatus 100 according to an exemplary environment.

As shown in FIG. 5, focus may move from a sub-screen 501 to a main screen 502, and when content C is selected based on a menu item list 503 which is provided according to a menu request, the apparatus 100 may change the main screen 502 displaying content B to a main screen 504 displaying the selected content C.

FIG. 6 illustrates an operation of searching for previous content in a multi-screen environment of the apparatus 100 according to an exemplary embodiment.

As shown in FIG. 6, as described above with reference to FIG. 1, when content is changed in the order of content A, content B, content C, and content D according to a menu request, both a sub-screen 603 displaying the content C and a main screen 604 displaying the content D may be displayed, and while the sub-screen 603 has focus, whenever a user input representing a previous content search input is received, the apparatus 100 may sequentially change the sub-screen 603 displaying the content C to a sub-screen 606 displaying the content B and a sub-screen 607 displaying the content A. Accordingly, the user is able to easily shuffle through the sub-screens 606 and 607 content which is previously selected, and may have a chance of reselecting content.

Previous content may be based on content which is selected after the apparatus 100 is powered on. When the apparatus 100 is powered off, information about the previous content may be deleted from the apparatus 100.

The apparatus 100 may be configured to set the number of pieces of content and/or a period where information about previous content is stored in an operation environment. For example, in a case where the user sets a period, where information about previous content is stored, to one week, even when the apparatus 100 is powered off, the apparatus 100 may maintain information about selected content for one week and may provide the information as described above.

For example, in a case where a setting is made by the user to store five pieces of information about previous content, even when the apparatus 100 is powered off, the apparatus 100 may maintain the selected five pieces of information about previous content and may provide the information as described above.

FIG. 7 illustrates an operation of searching for previous content in a multi-screen environment of the apparatus 100 according to an exemplary embodiment.

As shown in FIG. 7, in a state where content is changed in an order illustrated in FIG. 6, both a sub-screen 603 displaying content C and a main screen 604 displaying content D are displayed, and a sub-screen 503 has focus, when a user input representing a previous content search input is received, the apparatus 100 may display both a main screen 604 and sub-screens 701 to 703 corresponding to the number of previously selected pieces of content on the display 110. The number of previously selected pieces of content described in FIG. 7 may be set as described above with reference to FIG. 6.

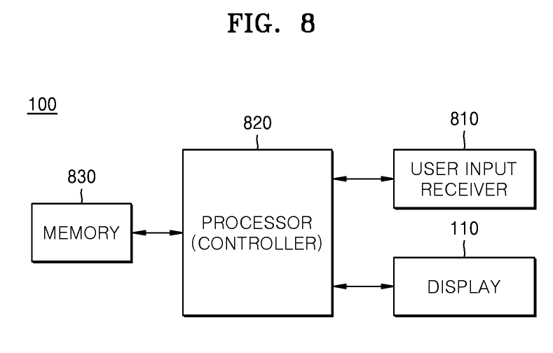

FIG. 8 is a function block diagram of an apparatus 100 according to an exemplary embodiment.

In FIG. 8, the apparatus 100 may include a display 110, a user input receiver 810, a processor 820, and a memory 830.

The display 110 may display at least one of the screens of the multiscreen illustrated in illustrated FIGS. 1 to 7.

The display 110 may be a liquid crystal display (LCD), a thin film transistor-liquid crystal display, an organic light-emitting diode display, a flexible display, a three-dimensional (3D) display, or an electrophoretic display (EPD). The display 110 may include, for example, a touch screen. However, a configuration of the display 110 is not limited thereto.

The user input receiver 810 may receive a user input. The user input receiver 810 may be configured to receive a touch-based user input, a button-based user input, a space gesture-based user input, an ultrasonic-based user input, and/or a voice recognition-based user input. The touch-based user input may include a touch-based user input based on a pen and/or a finger. However, in the present embodiment, the touch-based user input is not limited thereto.

The user input receiver 810 may include a communication module for transmitting or receiving data to or from the remote control device. For example, the communication module may include an infrared ray (IR) communication module, a radio frequency (RF) communication module, a Bluetooth communication module, a Wi-Fi direct communication module, and/or a Zigbee communication module. However, in the present embodiment, the communication module included in the user input receiver 810 is not limited thereto.

The communication module included in the user input receiver 810 may be determined based on a communication module included in the remote control device.

The processor 820 may be referred to as a controller for controlling all functions of the apparatus 100. The processor 820 may control the functions of the apparatus 100 in order for a multiscreen to be displayed on the display 110 according to a user input as illustrated in FIGS. 1 to 7.

The processor 820 may include one or more application processors (Aps). The processor 820 may drive an operating system (OS) or an operating program of the apparatus 100 to control a plurality of hardware or software elements connected to the processor 820. The processor 820 may perform processing and operations on various data including multimedia data.

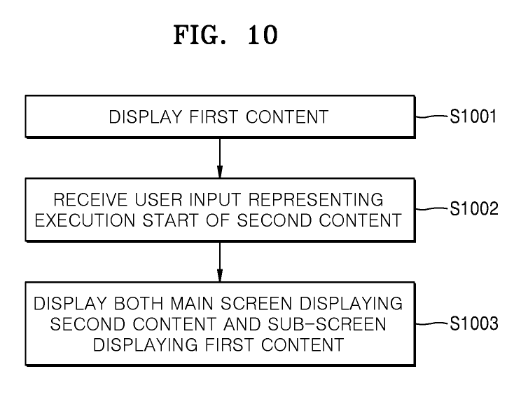

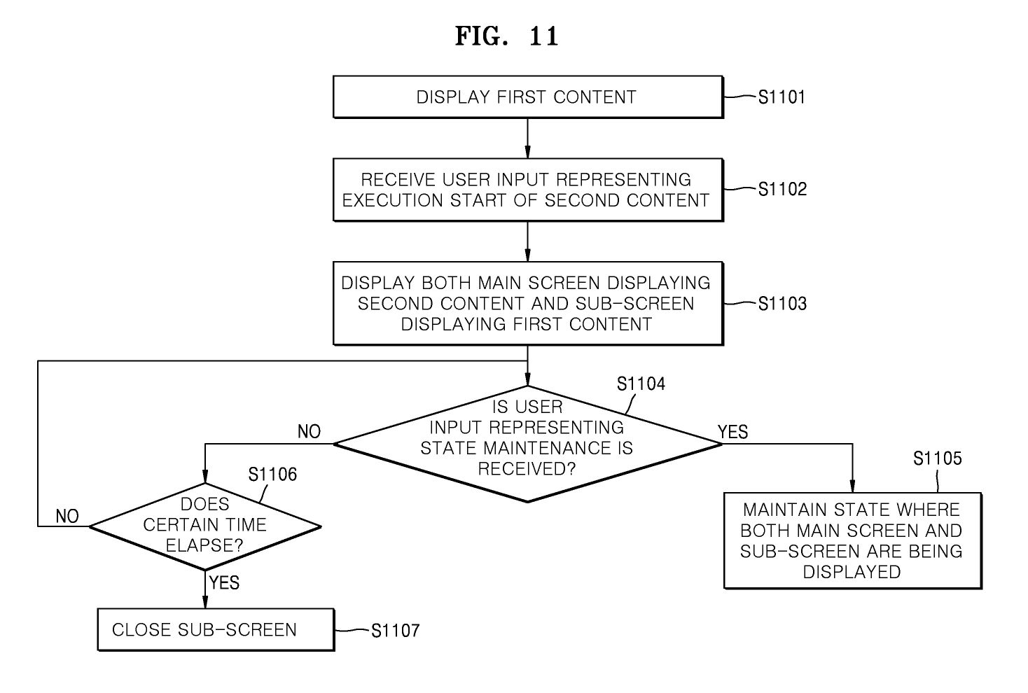

The processor 820 may provide through the display 110 a graphic user interface (GUI) based on FIGS. 1 to 7. The processor 820 may control the apparatus 100 to perform an operation based on a flowchart illustrated in FIG. 10 or 11.

The memory 830 may store a program and/or data which enables the apparatus 100 to provide a multi-screen environment on the display 110 by using the processor 820 as described above. For example, the memory 830 may store information for changing the display size and/or the display position of each of the sub-screen 104 and the main screen 105 according to the number of selections of the focused-screen size reduce item 302. The memory 830 may store menu items included in the menu list 102 and menu items included in the dedicated menu list 300, based on screen characteristic. The memory 830 coupled to the processor 820, wherein the memory 830 comprises instructions which, when executed by the processor 820, cause the processor 820 to perform operations according to exemplary embodiments of the present disclosure.

The memory 830 may include an internal memory and/or an external memory. The memory 830 may include a volatile memory such as dynamic random access memory (DRAM), static random access memory (SRAM), synchronous dynamic random access memory (SDRAM), or the like, a non-volatile memory such as one time programmable read-only memory (OTPROM), read-only memory (ROM), programmable read-only memory (PROM), erasable programmable read-only memory (EPROM), electrical erasable programmable read-only memory (EEPROM), mask ROM, flash ROM, NAND flash memory, NOR flash memory, or the like, flash drive such as solid-state drive (SSD), compact flash card, Secure Digital (SD) card, micro-SD card, mini-SD card, xD-Picture card, memory stick, or the like, or a storage device such as hard disk drive (HDD) or the like.

The function block diagram of the apparatus 100 according to an exemplary embodiment is not limited to the illustration in FIG. 8. For example, the apparatus 100 according to the present embodiment may include more elements or fewer elements than the number of the elements illustrated in FIG. 8.

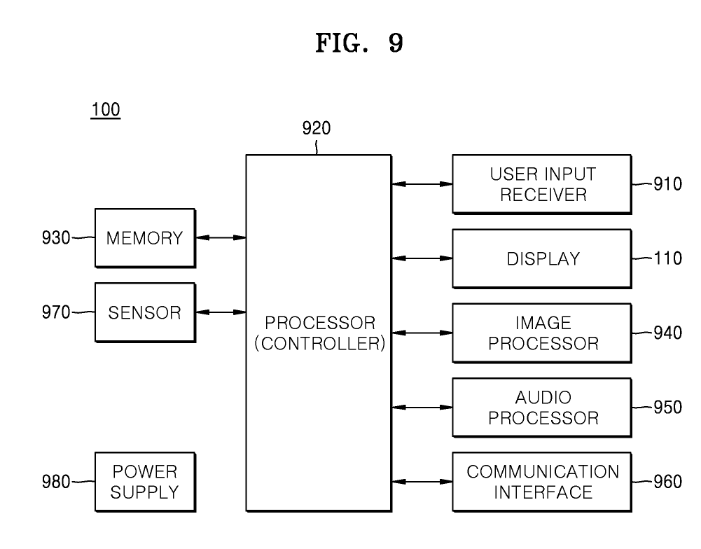

FIG. 9 is a function block diagram of an apparatus 100 according to an exemplary embodiment and illustrates a case of including more elements than the number of the elements illustrated in FIG. 8. In FIG. 9, the apparatus 100 may include a display 110, a user input receiver 910, a processor 920, a memory 930, an image processor 940, an audio processor 950, a communication interface 960, a sensor 970, and a power supply 980.

The user input receiver 910 and the display 110 illustrated in FIG. 9 may include elements and perform operations similar to the user input receiver 810 and the display 110 described above with reference to FIG. 8. Hereinafter, therefore, in order not to repeat repetitive descriptions, descriptions on the user input receiver 910 and the display 110 are omitted.

The processor 920 may have a configuration and perform an operation similar to the processor 820 illustrated in FIG. 8. The processor 920 may control operations of the image processor 940, the audio processor 950, the communication interface 960, the sensor 970, and the power supply 980.

The memory 930 may have a configuration and perform an operation similar to the memory 830 illustrated in FIG. 8. The memory 930 may store data and programs necessary for operations of the image processor 940, the audio processor 950, the communication interface 960, the sensor 970, and the power supply 980.

The image processor 940 may process image data received from the communication interface 960 or stored in the memory 930 so as to be displayed on the display 110. The image processor 940 may process the image data in order for a multiscreen to be displayed on the display 110.

The audio processor 950 may process audio data received from the communication interface 960 or stored in the memory 930 so as to be output. The audio processor 950 may convert an audio signal, received from the outside of the apparatus 100, into an electrical signal and may transmit the electrical signal to the processor 920 or may store the electrical signal in the memory 930. The audio processor 950 may include a function of recognizing a voice signal.

The audio processor 950 may include a function of removing external noise from the apparatus 100. The audio processor 950 may include a speaker and a microphone. When multiple screens are displayed on the display 110, the audio processor 950 may output an audio signal corresponding to content displayed on the multi-screen display. When the multi-screen display is displayed on the display 110, the audio processor 950 may output an audio signal corresponding to content displayed on the screen with focus.

The communication interface 960 may include one or more elements for communication between the apparatus 100 and at least one external device (e.g., a content providing server, a mobile device, a smartphone, a smart appliance, a wearable device such as a smartwatch, smart glasses, smart clothing, smart accessory, or the like, and/or an Internet of things (IoT)-based device).

For example, the communication interface 960 may include a short-range wireless communicator 1041, a mobile communicator 1042, and/or a broadcast receiver 1043, but elements included in the communication interface 960 are not limited thereto. For example, the communication interface 960 may include an element (or an interface), such as an HDMI, an USB, an optical communication terminal, a D-sub terminal, a jack, and/or the like, for a hardware connection.

The short-range wireless communicator 1041 may include a Bluetooth communication module, a Bluetooth low energy (BLE) communication module, a near-field communication (NFC) (or Radio Frequency Identification (RFID)) module, a WLAN (or Wi-Fi) communication module, a Zigbee communication module, an Ant+ communication module, a Wi-Fi direct (WFD) communication module, or an ultra-wideband (UWB) communication module, but is not limited thereto. For example, the short-range wireless communicator 1041 may include an infrared data association (IrDA) communication module.

The mobile communicator 1042 may transmit or receive a wireless signal to or from at least one of a base station, an external device, and a server over a mobile communication network. Here, the wireless signal may include various types of data based on transmission or reception of a voice call signal, a video call signal, or text/multimedia message.

The broadcast receiver 1043 may receive through a broadcast channel a broadcast signal and/or information about broadcast from the outside. The broadcast channel may include at least one of a satellite channel, a terrestrial channel, and a radio channel, but is not limited thereto. The broadcast receiver 1043 may include a plurality of tuners.

The communication interface 960 may transmit at least one piece of information, generated by the apparatus 100, to at least one external device or may receive information transmitted from the at least one external device.

The sensor 970 may include a proximity sensor that senses whether a user approaches the apparatus 100, a bio sensor (or a health sensor such as a heartbeat sensor, a blood flow rate sensor, a melituria sensor, a blood pressure sensor, and/or a stress sensor) that senses health information about the user, an illuminance sensor (or a light sensor or a light emitting diode (LED) sensor) that senses illumination around the apparatus 100, a mood scope sensor that senses a mood of the user of the apparatus 100, a motion sensor that senses activity, a position sensor (for example, a global positioning system (GPS) receiver) for detecting a position of the apparatus 100, a gyroscope sensor that measures a azimuth angle of the apparatus 100, an accelerometer sensor that measures a slope and an acceleration of the apparatus 100 with respect to a surface of the earth, and/or a geomagnetic sensor that senses an azimuth orientation with respect to the apparatus 100. However, in the present embodiment, a sensor included in the sensor 970 is not limited thereto.

For example, the sensor 970 may include a temperature/humidity sensor, a gravity sensor, an altitude sensor, a chemical sensor (e.g., an odorant sensor), an atmospheric pressure sensor, a fine dust sensor, an ultraviolet sensor, an ozone sensor, a carbon dioxide (CO₂) sensor, and/or a network sensor (e.g., a network sensor based on Wi-Fi, Bluetooth, 3G, long term evolution (LTE), and/or near field communication (NFC)), but is not limited thereto.

The sensor 970 may include a pressure sensor (e.g., a touch sensor, a piezoelectric sensor, a physical button, or the like), a state sensor (e.g., an earphone terminal, a digital multimedia broadcasting (DMB) antenna), a standard terminal (e.g., a terminal for recognizing whether charging is performed, a terminal for recognizing whether a PC is connected, or a terminal for recognizing whether a dock is connected), and/or a time sensor, but is not limited thereto. A result obtained through sensing by the sensor 970 may be transmitted to the processor 920. The processor 920 may determine whether the user is looking at the apparatus 100, based on a sensing value received from the sensor 970.

The power supply 980 may manage power of the apparatus 100. The power supply 980 may be configured as a battery type. The power supply 980 may include a power management integrated circuit (PMIC) or a charger integrated circuit (IC). The power supply 980 may be configured with a connector connectable to an external power source.

FIG. 10 is a flowchart of a method of providing a multi-screen environment performed by the apparatus 100 according to an exemplary embodiment.

In operation S1001, the apparatus 100 may display first content (e.g., the content A as described with reference to FIG. 1) on the display 110. When the first content is being displayed on the display 110, the apparatus 100 may receive a user input for starting second content (e.g., the content B illustrated in FIG. 1) in operation S1002. The user input for starting the second content may be received as described above with reference to FIG. 1.

Therefore, in operation S1003, the apparatus 100 may display both the main screen 105 displaying the second content and the sub-screen 104 displaying the first content on the display 110.

FIG. 11 is a flowchart of a method of providing a multi-screen environment performed by the apparatus 100 according to an exemplar embodiment.

Operations S1101 to S1103 illustrated in FIG. 11 may be performed in a similar fashion to operations S1001 to S1003 of FIG. 10, and thus, their detailed descriptions are not repeated below.

When a user input representing state maintenance (i.e., user request for the apparatus 100 to maintain its current multi-screen setup) is received in operation S1104, as described above with reference to FIG. 2, the apparatus may maintain a state where both the main screen 105 and the sub-screen 104 are being displayed on the display 110 in operation S1105. The user input representing state maintenance may be received as described above with reference to FIG. 2.

When the user input representing state maintenance is not received in operation S1104, the apparatus 100 may check whether a certain time (i.e., a threshold amount of time duration) elapses in operation S1106. Information about the certain time may be set in the apparatus 100. The information about the certain time may be changed by a user. The information about the certain time may be included in operation environment information about the apparatus 100.

When it is determined in operation S1106 that the certain time elapses, the apparatus 100 may close the sub-screen 104 as illustrated in FIG. 2 in operation S1107.

The embodiment may be implemented in the form of a storage medium that includes computer executable instructions, such as program modules, being executed by a computer. Computer-readable media may be any available media that may be accessed by the computer and includes both volatile and non-volatile media, removable and non-removable media. In addition, the computer-readable media may include computer storage media and communication media. Computer storage media includes the volatile and non-volatile, removable and non-removable media implemented as any method or technology for storage of information such as computer-readable instructions, data structures, program modules, or other data. The medium of communication is typically a computer-readable instruction, and other data in a modulated data signal such as data structures, or program modules, or other transport mechanism and includes any information delivery media.

The foregoing description of exemplary embodiments is for illustrative purposes, and those with ordinary skill may implement such concepts in other specific forms without changing the technical idea or essential features of the exemplary embodiments. Therefore, the embodiments described above are exemplary in all respects and are not limited to what is described. For example, each component described as being a single component may be distributed over multiple components, and two or more components may be combined into fewer components.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. An apparatus comprising:
a user interface configured to receive a user input;
a display; and
a processor configured to:
while first content is being displayed on the display, receive, through the user interface, a user input representing a request to start second content, and
in response to the received user input representing the request to start the second content, control the display to concurrently display the second content in a main screen of the display and the first content in a sub-screen of the display.

2. The apparatus of claim 1, wherein the processor is further configured to:
in response to a user input representing state maintenance being received through the user interface before a specific time duration elapses after the user input representing the request to start the second content is received, control the display to maintain a state in which the second content is displayed in the main screen and the first content is displayed in the sub-screen, and
in response to the user input representing state maintenance not being received until the specific time duration elapses after the user input representing the request to start the second content is received, control the display to close the sub-screen.

3. The apparatus of claim 1, wherein the processor is further configured to, in response to a user input representing a menu request being received through the user interface while one of the main screen and the sub-screen is being focused, control the display to provide a dedicated menu corresponding to the focused screen.

4. The apparatus of claim 3, wherein the dedicated menu comprises one or more menu items for at least one of toggling between multiple screens, reducing screen size of the focused screen, an increasing screen size of the focused screen, moving a screen, and terminating a multi-screen configuration.

5. The apparatus of claim 1, wherein the processor is further configured to, in response to a user input representing a request to start third content is received through the user interface while one of the main screen and the sub-screen is being focused, control the display to display the third content on the focused screen.

6. The apparatus of claim 1, wherein the processor is further configured to, in response to a user input representing a previous content search is received through the user interface, control the display to sequentially display previously selected content items on the sub-screen.

7. The apparatus of claim 1, wherein the processor is further configured to, in response to a user input representing a previous content search is received through the user interface, control the display to display previously selected content items on a plurality of sub-screens, a number of the plurality of sub-screens corresponding to a number of the previously selected content items.

8. A method of providing a multi-screen environment, the method comprising:
displaying first content on a display included in an apparatus;
while the first content is being displayed on the display, receiving, through a user interface included in the apparatus, a user input representing a request to start second content; and
in response to the received user input representing the request to start the second content, concurrently displaying the second content in a main screen of the display and the first content in a sub-screen of the display.

9. The method of claim 8, further comprising:
in response to a user input representing state maintenance being received through the user interface before a specific time duration elapses after the user input representing the request to start the second content is received, maintaining a state in which the second content is displayed in the main screen and the first content is displayed in the sub-screen; and
in response to the user input representing state maintenance being not received through the user interface until the specific time duration elapses after the user input representing the request to start the second content is received, closing the sub-screen in the display.

10. The method of claim 8, further comprising, in response to a user input representing a menu request being received through the user interface while one of the main screen and the sub-screen is being focused, providing, through the display, a dedicated menu corresponding to the focused screen.

11. The method of claim 10, wherein the dedicated menu comprises one or more menu items for at least one of toggling between multiple screens, reducing screen size of the focused screen, increasing screen size of the focused screen, moving a screen, and terminating a multi-screen configuration.

12. The method of claim 8, further comprising:
receiving a user input representing a request to start third content through the user interface while one of the main screen and the sub-screen is being focused; and
displaying the third content on the focused screen.

13. The method of claim 8, further comprising, in response to a user input representing a previous content search being received through the user interface, sequentially displaying previously selected content items on the sub-screen.

14. The multiscreen providing method of claim 8, further comprising, in response to a user input representing a previous content search being received through the user interface, displaying previously selected content items on a plurality of sub-screens, a number of the plurality of sub-screens corresponding to a number of the previously selected content items.

15. A non-transitory computer-readable storage medium storing a program for executing a method comprising:
displaying first content on a display included in an apparatus;
while the first content is being displayed on the display, receiving, through a user interface included in the apparatus, a user input representing a request to start second content; and
in response to the received user input representing the request to start the second content, concurrently displaying the second content in a main screen of the display and the first content in a sub-screen of the display.

16. The apparatus of claim 1, wherein at least one of the main screen and the sub-screen is a virtual screen displayed on the display.
